(19) United States
(12) Patent Application Publication
(10) Pub. No.: US 2009/0083392 A1
(43) Pub. Date: Mar. 26, 2009

(54) SIMPLE, EFFICIENT RDMA MECHANISM

(75) Inventors: Michael K. Wong, Cupertino, CA (US); Rabin A. Sugumar, Sunnyvale, CA (US); Stephen E. Phillips, Los Gatos, CA (US); Hugh Kurth, Lexington, MA (US); Suraj Sudhir, Sunnyvale, CA (US); Jochen Behrens, Santa Cruz, CA (US)

Correspondence Address: BROOKS KUSHMAN P.C. / SUN / STK, 1000 TOWN CENTER, TWENTY-SECOND FLOOR, SOUTHFIELD, MI, 48075-1238, US

(73) Assignee: Sun Microsystems, Inc., Santa Clara, CA (US)

(21) Appl. No.: 11/860,934

(22) Filed: Sep. 25, 2007

(51) Int. Cl. G06F 15/167; G06F 15/16

(52) U.S. Cl. 709/212; 709/203; 709/206

(57) ABSTRACT

A server interconnect system for sending data includes a first server node and a second server node. Each server node is operable to send and receive data. The interconnect system also includes a first and second interface unit. The first interface unit is in communication with the first server node and has one or more RDMA doorbell registers. Similarly, the second interface unit is in communication with the second server node and has one or more RDMA doorbell registers. The system also includes a communication switch that is operable to receive and route data from the first or second server nodes using a RDMA read and/or an RDMA write when either of the first or second RDMA doorbell registers indicates that data is ready to be sent or received.

### 1. FIELD OF THE INVENTION

In at least one aspect, the present invention relates to communication within a cluster of computer nodes.

### 2. BACKGROUND ART

A computer cluster is a group of closely interacting computer nodes operating in a manner so that they may be viewed as though they are a single computer. Typically, the component computer nodes are interconnected through fast local area networks. Internode cluster communication is typically accomplished through a protocol such as TCP/IP or UDP/IP running over an ethernet link, or a protocol such as uDAPL or IPoIB running over an Infiniband (“IB”) link. Computer clusters offer cost effective improvements for many tasks as compared to using a single computer. However, for optimal performance, low latency cluster communication is an important feature of many multi-server computer systems. In particular, low latency is extremely desirable for horizontally scaled databases and for high performance computer (“HPC”) systems.

Although present day cluster technology works reasonably well, there are a number of opportunities for performance improvements regarding the utilized hardware and software. For example, ethernet does not support multiple hardware channels with user processes having to go through software layers in the kernel to access the ethernet link. Kernel software performs the mux/demux between user processes and hardware. Furthermore, ethernet is typically an unreliable communication link. The ethernet communication fabric is allowed to drop packets without informing the source node or the destination node. The overhead of doing the mux/demux in software (trap to the operating system and multiple software layers) and the overhead of supporting reliability in hardware result in significant negative impact on application performance.

Similarly, Infiniband (“IB”) offers several additional opportunities for improvement. IB defines several modes of operation such as Reliable Connection, Reliable Datagram, Unreliable Connection and Unreliable Datagram. Each communication channel utilized in IB Reliable Datagrams requires the management of at least three different queues. Commands are entered into send or receive work queues. Completion notification is realized through a separate completion queue. Asynchronous completion results in significant overhead. When a transfer has been completed, the completion ID is hashed to retrieve context to service the completion. In IB, receive queue entries contain a pointer to the buffer instead of the buffer itself resulting in buffer management overhead. Moreover, send and receive queues are tightly associated with each other. Implementations cannot support scenarios such as multiple send channels for one process, and multiple receive channels for others, which is useful in some cases. Finally, reliable datagram is implemented as a reliable connection in hardware, and the hardware does the muxing and demuxing based on the end-to-end-context provided by the user. Therefore, IB is not truly connectionless and results in a more complex implementation.

Remote Direct Memory Access (“RDMA”) is a data transfer technology that allows data to move directly from the memory of one computer into that of another without involving either computer's operating system. This permits high-throughput, low-latency networking, which is especially useful in massively parallel computer clusters. The primary reason for using RDMA to transfer data is to avoid copies. The application buffer is provided to the remote node wishing to transfer data, and the remote node can do a RDMA write or read from the buffer directly. Without RDMA, messages are transferred from the network interface device to kernel memory. Software then copies the messages into the application buffer. Several studies have shown that when transferring large blocks over an interconnect the dominant cost lies in performing copies at the sender and the receiver.

However, to perform RDMA the buffers at the source and the destination need to be made accessible to the network device participating in RDMA. This process involves two steps referred to herein as buffer registration. In the first step, the buffer in memory is pinned so that the operating system does not swap it out. In the second step, the physical address or an I/O virtual address (“I/O VA”) of the buffer is obtained and sent to the device so the device knows the location of the buffer. As used herein, these two steps are referred to as buffer registration.

Buffer registration involves operating system operations and is expensive to perform. Accordingly, RDMA is not efficient for small buffers—the cost of setting up the buffers is higher than the cost of performing copies. Studies indicate that the crossover point where RDMA becomes more efficient than normal messaging is 2 KB to 8 KB. It should also be appreciated that buffer registration needs to be performed just once on buffers used in normal messaging, since the same set of buffers are used repeatedly by the network device with data being copied from device buffers to application buffers.

Two approaches are used to reduce impact of buffer registration. The first approach is to register the entire memory of the application when the application is started. For large applications this causes a significant fraction of physical memory to be locked down and unswappable. Furthermore, other applications are prevented from being run efficiently on the server. The second approach is to cache registrations. This technique has been used in a few MPI implementations. MPI is a cluster communication, API is used primarily in HPC applications. In this approach recently used registrations are saved in a cache. When the application tries to reuse the registrations, the cache is checked, and if the registration is still available they are serviced from the cache.

Accordingly, there exists a need for improved methods and systems for connectionless internode cluster communication.

### SUMMARY OF THE INVENTION

The present invention solves one or more problems of the prior art by providing in at least one embodiment, a server interconnect system providing communication within a cluster of computer nodes. The server interconnect system for sending data includes a first server node and a second server node. Each server node is operable to send and receive data. The interconnect system also includes a first and second interface unit. The first interface unit is in communication with the first server node and has one or more Remote Direct Memory Access (“RDMA”) doorbell registers. Similarly, the second interface unit is in communication with the second server node and has one or more RDMA doorbell registers. The system also includes a communication switch that is operable to receive and route data from the first or second server nodes using an RDMA read and/or an RDMA write when either of the first or second RDMA doorbell registers indicates that data is ready to be sent or received. Advantageously, the server interconnect system of the present embodiment is reliable and connectionless while supporting messaging between the nodes. The server interconnect system is reliable in the sense that packets are never dropped other than in catastrophic situations such as hardware failure. The server interconnect system is connectionless in the sense that hardware treats each transfer independently, with specified data moved between the nodes and queue/memory addresses specified for the transfer. Moreover, there is no requirement to perform a handshake before communication starts or to maintain status information between pairs of communicating entities. Latency characteristics of the present embodiment are also found to be superior to the prior art methods.

In another embodiment of the present invention, a method of sending a message from a source node to a target node via associated interface units and a communication's switch is provided. The method of this embodiment implements an RDMA write by registering a source buffer that is the source of the data. Similarly, a target buffer that is the target of the data is also registered. An RDMA descriptor is created in system memory of the source node. The RDMA descriptor has a field that specifies identification of the target node with which an RDMA transfer will be established a field for the address of the source buffer, a field for the address of the target buffer, and an RDMA status field. The address of the RDMA descriptor is written to a set of first RDMA doorbell registers located within a source interface unit. An RDMA status register is set to indicate an RDMA transfer is pending. Next, the data to be transferred, the address of the target buffer and target node identification is provided to the server communication switch, thereby initiating an RDMA transfer of the data to the target server node.

In another embodiment of the present invention, a method of sending a message from a source node to a target node via associated interface units and a communication's switch is provided. The method of this embodiment implements an RDMA read by registering a source buffer that is the source of the data. A source buffer identifier is sent to the target server node. A target buffer that is the target of the data is registered. An RDMA descriptor is created in system memory of the target node. The RDMA descriptor has a field for the identification of the target node with which an RDMA transfer will be established, a field for the address of the source buffer, a field for the address of the target buffer, and an RDMA status field. The address of the RDMA descriptor is written to one of a set of RDMA doorbell registers. An RDMA status register is set to indicate an RDMA transfer is pending. A request is sent to the source interface unit to transfer data from the source buffer. Finally, the data from the source buffer is sent to the target buffer.

### BRIEF DESCRIPTION OF THE DRAWINGS

FIG. 1 is a schematic illustration of an embodiment of a server interconnect system;

FIG. 2A is a schematic illustration of an embodiment of an interface unit used in server interconnect systems;

FIG. 2B is a schematic illustration of an RMDA descriptor which is initially in system memory;

FIGS. 3A, B, C and D provide a flowchart of a method for transferring data between server nodes via an RDMA write; and

FIGS. 4A, B, C and D provide a flowchart of a method for transferring data between server nodes via an RDMA read.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

In an embodiment of the present invention, a server interconnect system for communication within a cluster of computer nodes is provided. In a variation of the present embodiment, the server interconnect system is used to connect multiple servers through a PCI-Express fabric.

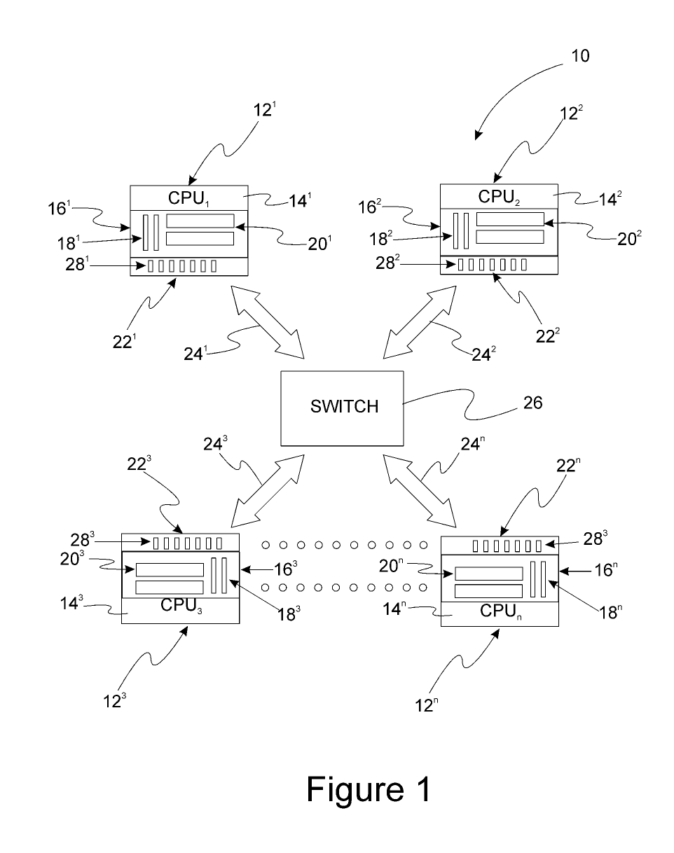

With reference to FIG. 1, a schematic illustration of the server interconnect system of the present embodiment is provided. Server interconnect system 10 includes server nodes 12ⁿ. Since the system of the present invention typically includes a plurality of nodes (i.e., n nodes as used herein), the superscript n which be used to refer to the configuration of a typical node with associated hardware. Each of server nodes 12ⁿ includes a CPU 14ⁿ and system memory 16ⁿ. System memory 16ⁿ includes buffers 18ⁿ which hold data received from a remote sever or data to be sent to a remote server. Remote in this context includes any other server node than the one under consideration. Data in the context of the present invention includes any form of computer readable electronic information. Typically, such data is encoded on a storage device (e.g., hard drive, tape drive, optical drives, system memory, and the like) accessible to server nodes 12ⁿ. Messaging and RDMA are initiated by writes to doorbell registers implemented in hardware as set forth below. The term “doorbell” as used herein means a register that contains information which is used to initiate an RDMA transfer. The content of an RDMA write specifies the source node and address and the destination node address to which the data is to be written. Advantageously, the doorbell registers can be mapped into user processes. Moreover, the present embodiment allows RDMA transfers to be initiated at the user level.

Still referring to FIG. 1, interface units 22ⁿ are associated with server nodes 12ⁿ. Interface units 22ⁿ are in communication with each other via communication links 24ⁿ to server switch 26. In one variation, interface units 22ⁿ and server switch 26 are implemented as separate chips. In another variation, interface units 12ⁿ and server switch 26 are both located within a single chip. The system of the present embodiment utilizes at least two modes of operation—RDMA write and RDMA read. In RDMA write, the contents of a local buffer 18¹ are written to a remote buffer 18².

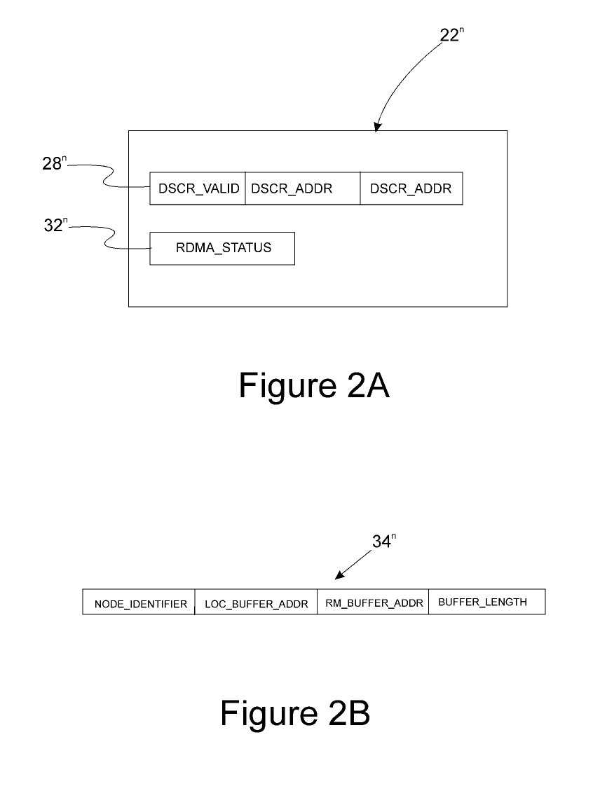

With reference to FIGS. 1, 2A, and 2B, the utilization of one or more RDMA doorbell registers to send and receive data is illustrated. FIG. 2A is a schematic illustration of an embodiment of a interface unit used in server interconnect systems. FIG. 2B is a schematic illustration of an RMDA descriptor which is initially in system memory. Each of server nodes 12ⁿ has an associated set of RDMA doorbell registers. Set of RDMA doorbell registers 28ⁿ is located within interface unit 22ⁿ and is associated with sever node 12ⁿ. Each RDMA doorbell register 28ⁿ is used to initiate an RDMA operation. It is currently inconvenient to write more than 8B (64 bits) to a register with one instruction. In a variation of the present embodiment, since it usually takes more than 64 bits to fully specify an RDMA operation, a descriptor for the RDMA operation is created in system memory. The RDMA descriptor 34ⁿ is read by interface unit 22² to determine the address of the source and destination buffers and the size of the RDMA. Typical fields in the RDMA descriptor 34ⁿ include those listed in Table 1.

TABLE 1
RDMA descriptor fields

| Field | Description |
|---|---|
| NODE_IDENTIFIER | Remote Node identifier |
| LOC_BUFFER_ADDR | Local buffer address |
| RM_BUFFER_ADDR | Remote buffer address |
| BUFFER_LENGTH | Size of the buffer |

Software writes the address of the descriptor into the RDMA doorbell register to initiate the RDMA. In one variation, RDMA send doorbell register 28ⁿ includes the fields provided in Table 2. The sizes of these fields are only illustrative of an example of RDMA send doorbell register 28ⁿ.

TABLE 2

| Field | Description |
|---|---|
| DSCR_VALID | 1 bit (indicates if descriptor is valid) |
| DSCR_ADDR | ~32 bits (location of descriptor that |
| | describes RDMA to be performed) |
| DSCR_SIZE | 8 bits (size of descriptor) |

The set of message send registers also includes RDMA send status register 32ⁿ. RDMA send status register 32ⁿ is associated with doorbell register 28ⁿ. Send status register 32ⁿ contains the status of the message send initiated through a write into send doorbell register 28ⁿ. In a variation, send status register 32ⁿ includes at least one field as set forth in Table 2. The size of this field is only illustrative of an example of RDMA send status register 32ⁿ.

TABLE 3

| Field | Description |
|---|---|
| RDMA_STATUS | ~8 bits (status of RDMA: pending, |
| | done, error, type of error) |

In a variation of the present embodiment, each interface unit 22ⁿ typically contains a large number of RDMA registers (on the order of 1000 or more). Each software process/thread on a server that wishes to RDMA data to another server is allocated an RDMA doorbell register and an associated RDMA status register.

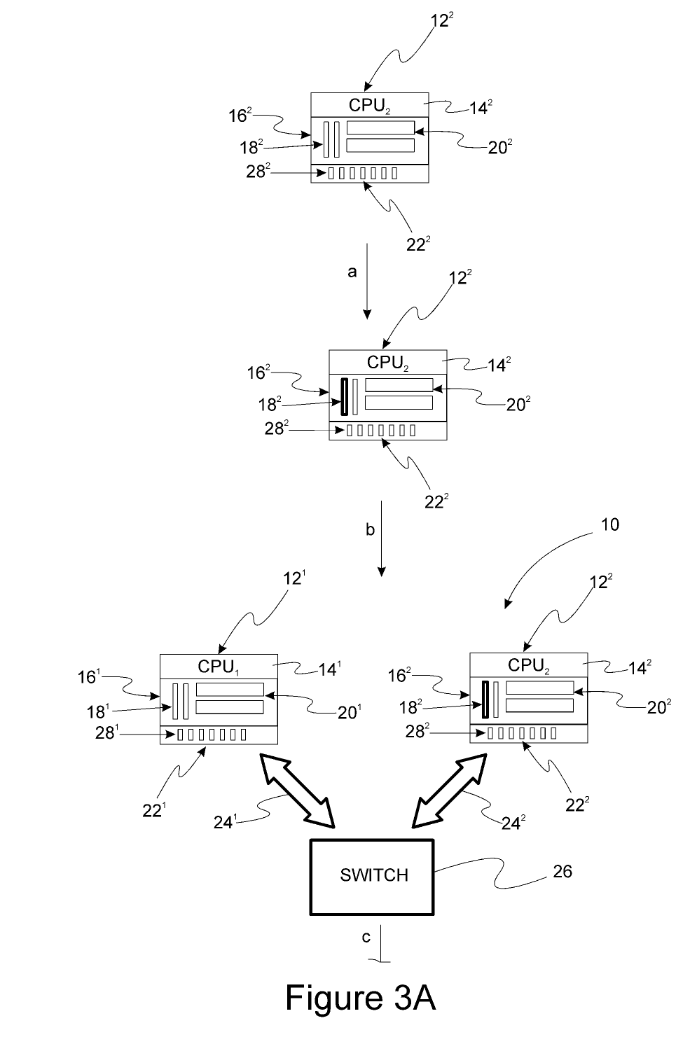

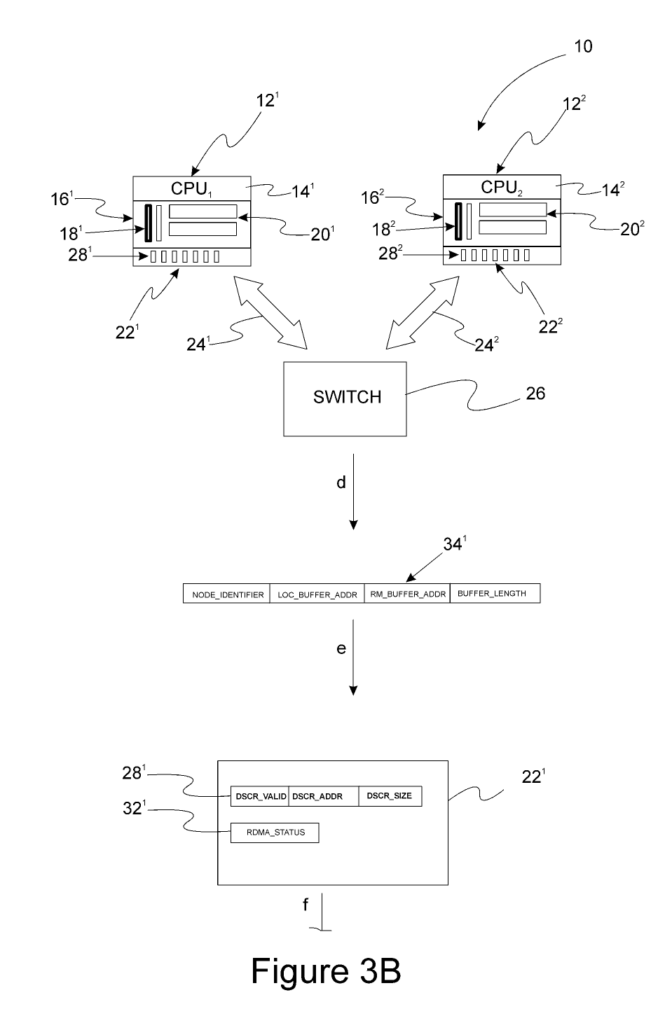

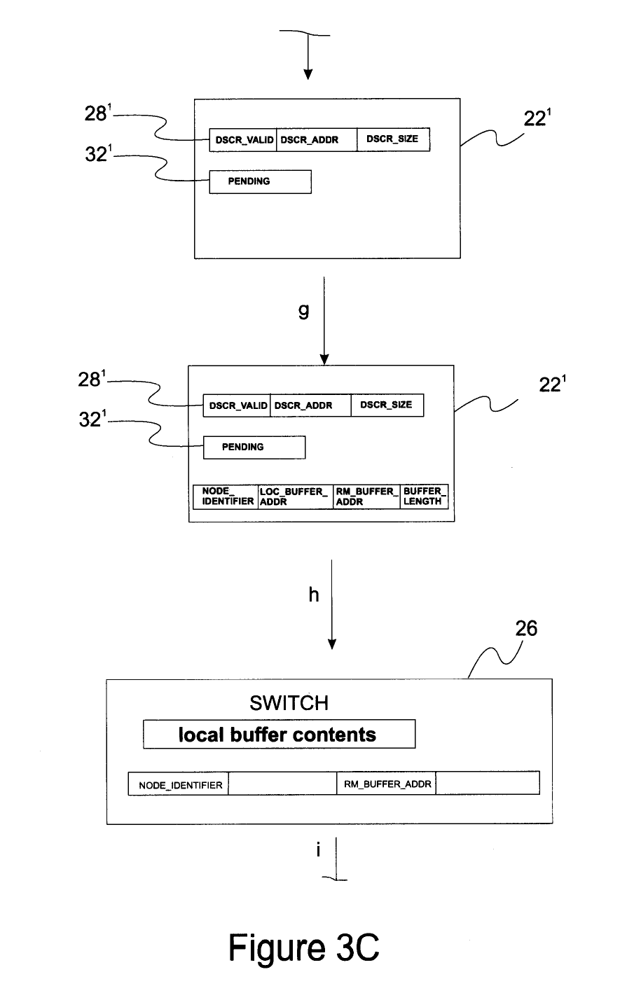

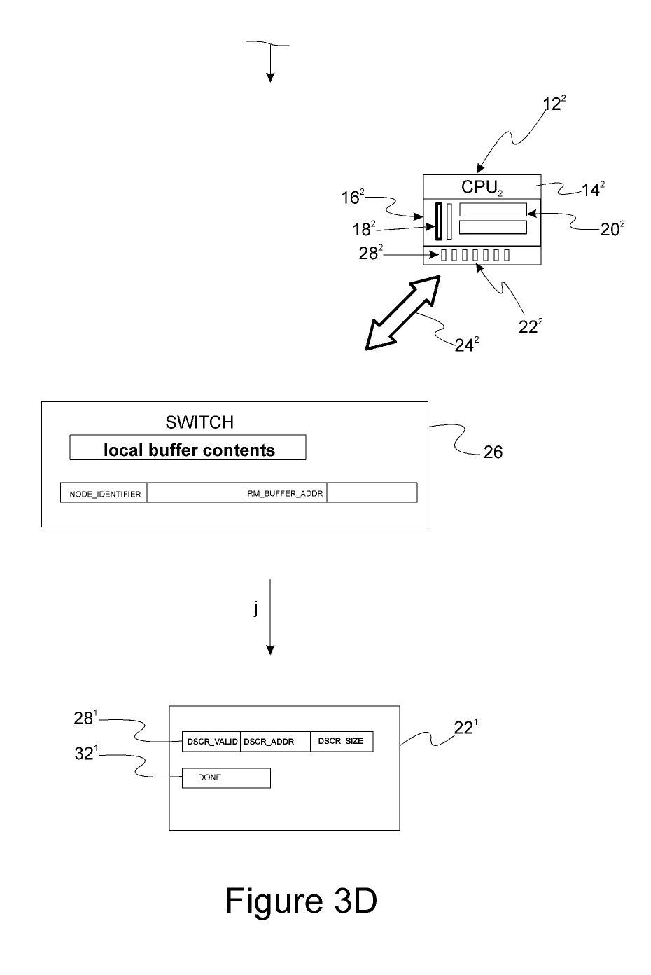

With reference to FIGS. 1, 2A, 2B, and 3A-D, an example of an RMDA write communication utilizing the server interconnect system set forth above is provided. FIGS. 3A-D, provide a flowchart of a method for transferring data between server nodes via an RDMA write. In this example, communication is between source server node 12¹ and target server node 12² with data to be transferred identified. Executing software on server node 12² registers buffer 18² that is the target of the RDMA to which data is to be transferred as shown in step a). In step b), Software on server 12² then sends an identifier for the buffer 18² to server 12¹ through some means of communication (e.g. a message). Executing software on server node 12¹ registers buffer 18¹ that is the source of the RDMA (step c)). In step d), Software on 12¹ then creates an RDMA descriptor 34¹ that includes the address of buffer 18¹ and the address of buffer 18² (sent over by software from server 12² earlier). Software on 12¹ then writes the address and size of the descriptor into the RDMA doorbell register 28¹ as shown in step e).

When hardware in the interface unit 22¹ sees a valid doorbell as indicated by the DSCR_VALID field, the corresponding RDMA status register 32¹ is set to the pending state as set forth in step f). In step g), hardware within interface unit 22¹ then performs a DMA read to get the contents of the descriptor from system memory of source server node 12¹. In step h), the hardware within interface unit 22¹ then reads the contents of the local buffer 18¹ from system memory on source server 18¹ using the RDMA descriptor and then sends the data along with the target address and the target node identification to server communication switch 26.

Server communication switch 26 routes the data to the to buffer 18² of target server node 12² as set forth in step i). In step i), interface unit 22² at the target server 12² performs a DMA write of received data to the specified target address. An acknowledgment (“ack”) is then sent back to source server node 12¹. Once the source node 12¹ receives the ack it updates the send status register to ‘done’ as shown in step j).

Software executing on the source node polls the RDMA status register. When it sees status change from “pending” to “done” or “error,” it takes the required action. Optionally, software on the source node could also wait for an interrupt when the RDMA completes. Typically, the executing software on the destination node has no knowledge of the RDMA operation. The application has to define a protocol to inform the destination about the completion of an RDMA. Typically this is done through a message from the source node to the destination node with information on the RDMA operation that was just completed.

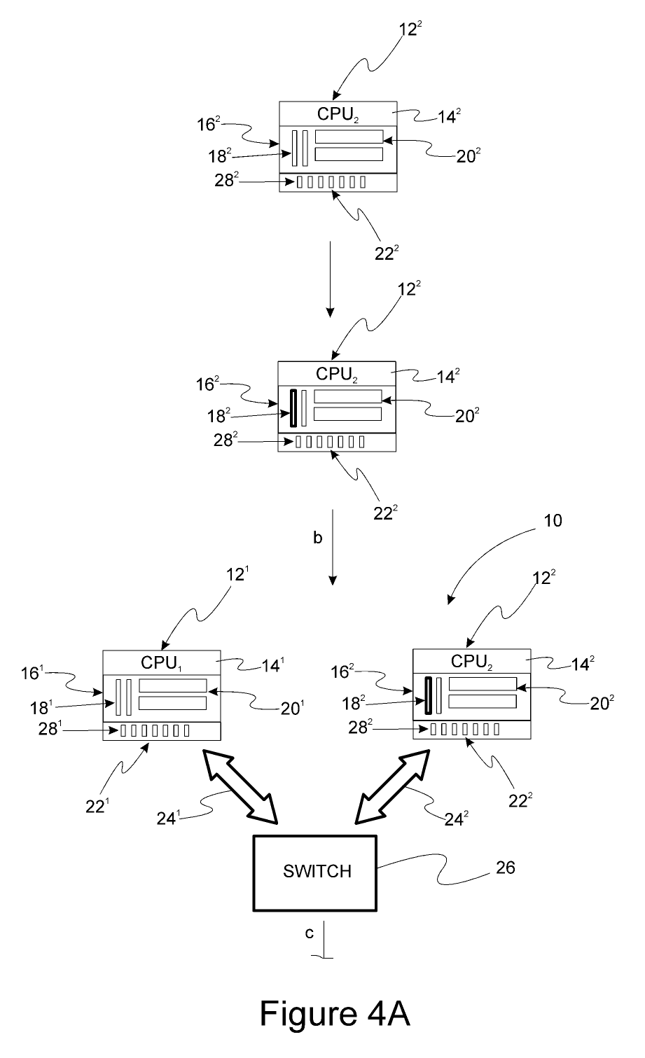

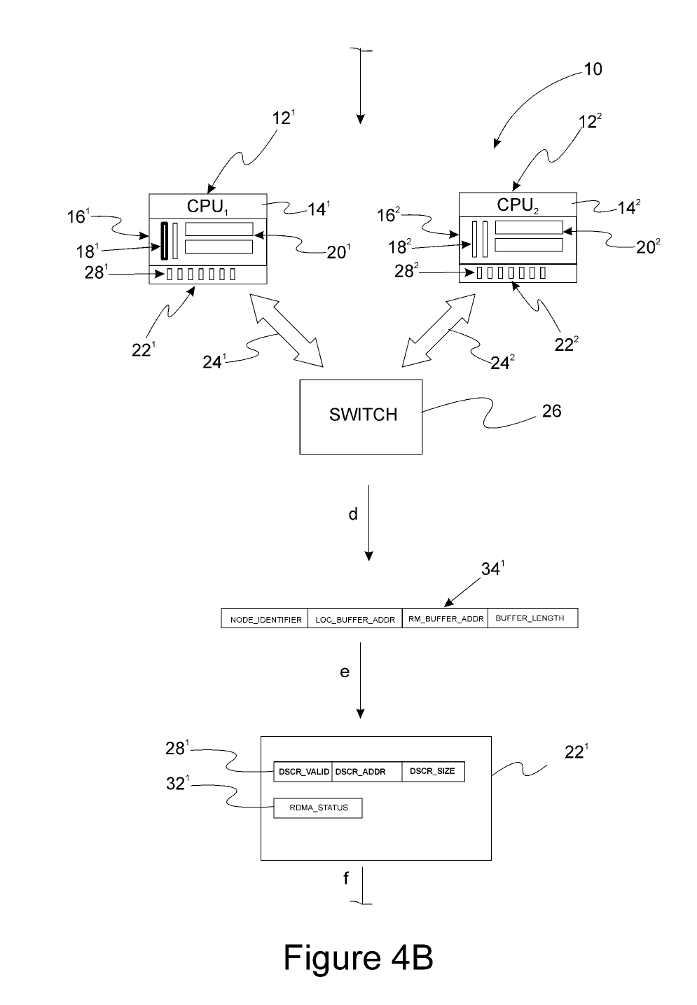

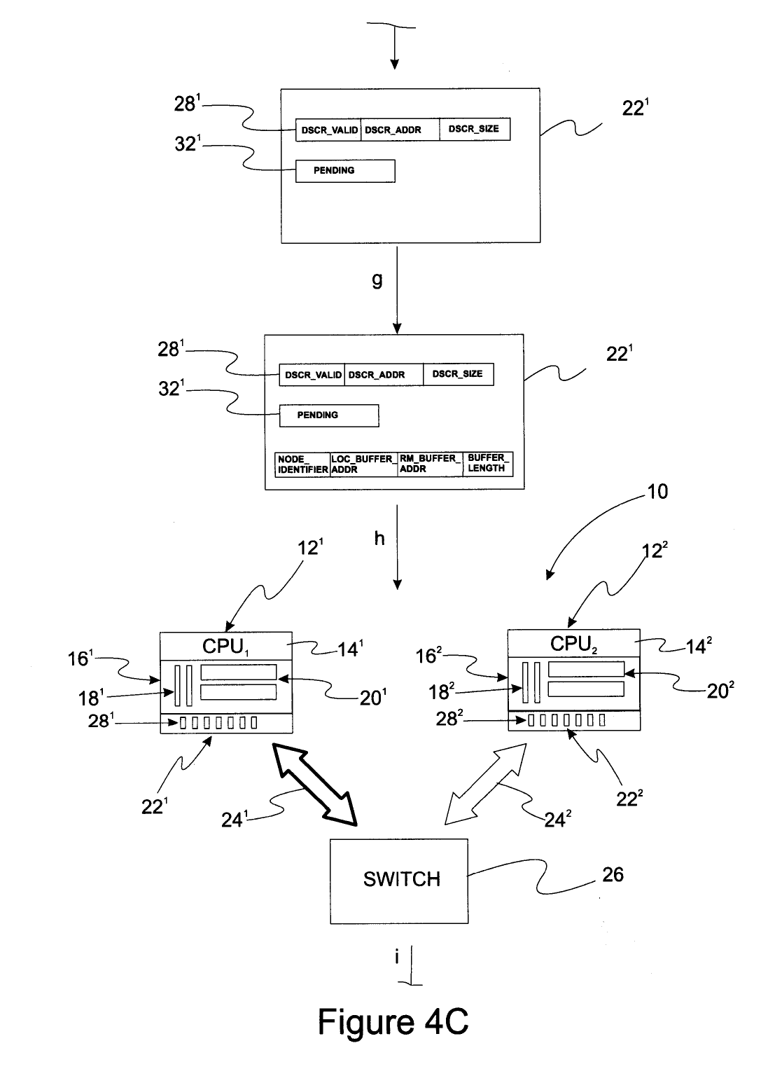

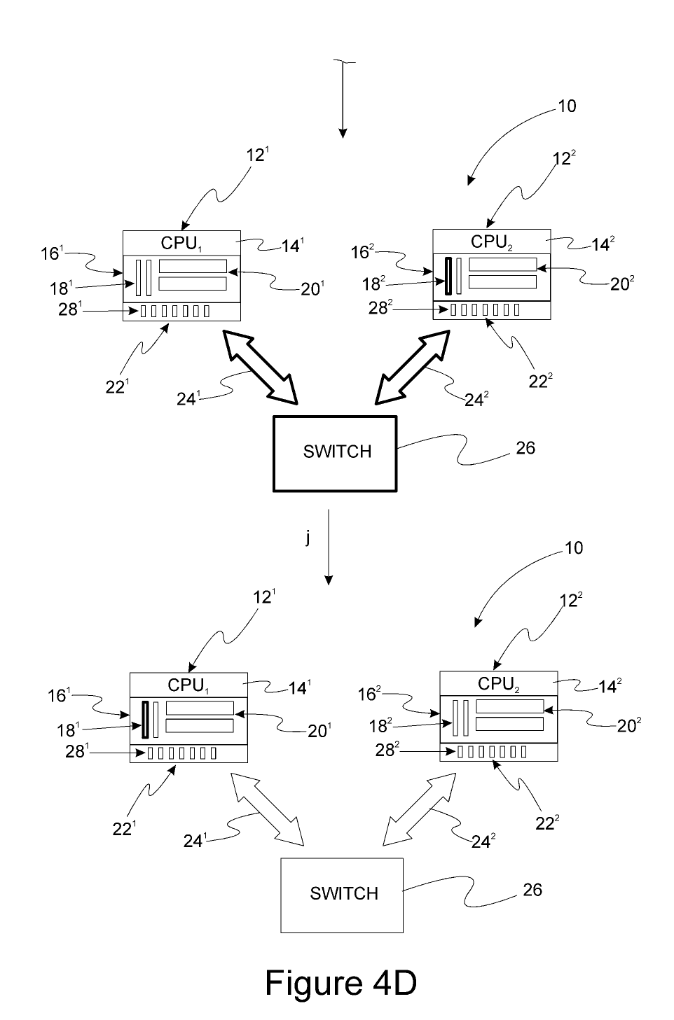

With reference to FIGS. 1, 2A, 2B, and 4A-D, an example of an RMDA read communication utilizing the server interconnect system set forth above is provided. FIGS. 4A-C, provide a flowchart of a method for transferring messages between server nodes via an RDMA read. In this example, communication is between server node 12¹ and server node 12², where server node 12¹ performs an RDMA read from a buffer on server node 12². Executing software on server node 12² registers buffer 18² that is the source of the RDMA from which data is to be transferred as shown in step a). Software on server 12² then sends an identifier for the buffer 18² to server 12¹ through some means of communication (e.g. a message) in step b). Executing software on server node 12¹ registers buffer 18¹ that is the target of the RDMA in step c). In step d), software on 12¹ then creates an RDMA descriptor 34¹ that includes the address of buffer 18¹ and the address of buffer 18² (sent over by software from server 12² earlier). In step e), software on 12¹ then writes the address and size of the descriptor into the RDMA doorbell register 28¹.

When hardware on the interface unit 22¹ sees a valid doorbell, it sets the corresponding RDMA status register 32¹ to the pending state in step f). In step g), hardware within interface unit 22¹ then performs a DMA read to get the contents of the descriptor 34¹ from system memory. The hardware within interface unit 22¹ obtains the identifier for buffer 18² from the descriptor 34¹, and sends a request for the contents of the remote buffer 18² to server communication switch 26 in step h). In step i), server communication switch 26 routes the request to interface unit 22². Interface unit 22² performs a DMA read of the contents of buffer 18² and sends the data back to switch 26 which routes the data back to interface unit 22¹. In step j), interface unit 22¹ then performs a DMA write of the data into buffer 18¹. Once the DMA write is complete, interface unit 22¹ updates the send status register to ‘done’.

Server communication switch 26 routes the data to local buffer 18¹ as set forth in step f). Interface unit 22¹ at the server 12¹ performs a DMA read of the data at the specified target address. An acknowledgment (“ack”) is then sent back to source server node 12¹. Once the source node 12¹ receives the ack it updates the send status register to ‘done’ as shown in step g).

When the size of the buffer to be transferred in the read and write RDMA communications set forth above is large, the transfer is segregated into multiple segments. Each segment is then transferred separately. The source server sets the status register when all segments have been successfully transferred. When errors occur, the target interface unit 22ⁿ sends an error message back. Depending on the type of error, the source interface unit 22ⁿ either does a retry (sends data again), or discards the data and sets the RDMA_STATUS field to indicate the error. Communication is reliable in the absence of unrecoverable hardware failure.

In another variation of the present invention, function calls in a software API are used for performing an RDMA. These calls can be folded into an existing API such as sockets or can be defined as a separate API. On each server 12ⁿ there is a driver that attaches to the associated interface unit 22ⁿ. The driver controls all RDMA registers on the interface unit 22ⁿ and allocates them to user processes as needed. A user level library runs on top of the driver. This library is linked by an application that performs RDMA. The library converts RDMA API calls to interface unit 22ⁿ register operations to perform RDMA operations as set forth in Table 4.

TABLE 4

| Operation | Description |
|---|---|
| register | designates a region of memory as |
| | potentially involved in RDMA |
| deregister | indicates that a region of memory will |
| | no longer be involved in RDMA |
| get_rdma_handle | gets an I/O virtual address for a |
| | buffer |
| rdma_write | initiates an RDMA write operation |

The application calls “register” with a start and end address for a contiguous region of memory. This indicates to the user library that the region of memory might participate in RDMA operations. The library records this information in an internal data structure. The application guarantees that the region of memory passed through the register call will not be freed until the application calls “deregister” for the same region of memory or exits.

The applications calls “get_rdma_handle” with a buffer start address and a size. The buffer should be contained in a region of memory that was registered earlier. The user level library pins the buffer by performing the appropriate system call. An I/O virtual address is obtained for the buffer by performing another system call which returns a handle (I/O virtual address) for the buffer. The application is free to perform RDMA operations to the I/O virtual address at this point.

The library does not have to perform the pin and I/O virtual address get operations when a handle for the buffer is found in the registration cache. The application calls “rdma_write” with a handle for a remote buffer, and a handle for a local buffer. The library contains an RDMA doorbell register and status register from the driver and maps them, creates a RDMA descriptor, and writes descriptor address and size into the RDMA doorbell. It then polls the status register until the status indicates completion or error. In either case, it returns the appropriate code to the application.

Optionally, the application may just provide a local buffer address and size, and allow the library to create the local handle. Also optionally, the API may include an RDMA initialization call for the library to acquire and map RDMA doorbell and status registers, that are then used on subsequent RDMA operations.

The application indicates to the library that the buffer will no longer be used for RDMA operations. The library can at this point unpin the buffer and release the I/O virtual address if it so desires. It may also continue to have the buffer pinned and hold the I/O virtual address in a cache, to service a subsequent get^{—}rdma_handle call on the same buffer.

The application calls “deregister” with a start and end address for a region of memory. This indicates to the library that the region of memory will no longer participate in RDMA operations, and the application is even allowed to deallocate the region of memory from its address space. At this point, the library has to delete any buffers that it holds in its cache that are contained in the region, i.e. unpin the buffers and release their I/O virtual address.

In a variation of the invention, the registration cache is implemented as a hash table. The key into the hash table is the page address of a buffer in the application's virtual address space, where page refers to the unit of granularity at which I/O virtual addresses are allocated (I/O page size is typically 8 KB).

In another variation of the present embodiment, each entry of the registration cache typically contains the fields listed in Table 5.

TABLE 5

| Field | Description |
|---|---|
| Application virtual address | 64 bits virtual address of buffer as |
| | seen by application at page granularity |
| I/O virtual address | 64 bits virtual address of buffer as |
| | seen by I/O device at page granularity |
| Status | 8 bits (Valid, Active, Inactive) |
| Timestamp | 32 bits Time of last use |

An entry is added to the cache during a “get_rdma_handle call”. The following steps are performed as part of the “get_rdma_handle call”. The page virtual address of the buffer and index into hash table are obtained. If a valid hash entry is found, the “Status” is set to “Active” and a handle is returned. If a valid handle is not found, system calls are executed to pin the page and obtain an I/O virtual address, create a new hash entry and insert into table, and set “Status” to “Valid” and “Active” with a handle being returned. When “free_rdma_handle” is called, the corresponding hash table entry is set to “Inactive.”

The library keeps track of the total size of memory that is pinned at any point in time. Once size of pinned memory crosses a user settable threshold (defined as a fraction of total physical memory, e.g., ½ or ¾), the library walks through the entire hash table and frees all hash table entries whose “Status” is “Inactive”, and whose last time of use was further back than another user settable threshold (e.g., more than 1 hour back). When “deregister” is called on a region, the library walks down the hash table and releases all entries that are contained in the region being deregistered.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A server interconnect system for sending a message, the system comprising:
a first server node operable to send and receive data;
a second server node operable to send and receive data;
a first interface unit in communication with the first server node, the first interface unit having a first Remote Direct Memory Access (“RDMA”) doorbell register and an RDMA status register;
a second interface unit in communication with the second server node, the second interface unit having a second RDMA doorbell register; and
a communication switch, the communication switch is operable to receive and route data from the first or second server nodes using a RDMA read and/or an RDMA write when either of the first or second RDMA doorbell register indicates that data is ready to be sent or received.

2. The server interconnect system of claim 1 further comprising one or more additional server nodes and one or more additional interface units, each additional interface unit having an associated set of RDMA doorbell registers, each additional server node in communication with one of the additional interface units wherein the switch is operable to receive and route data between the first server node, the second server node, and the additional server nodes when any associated RDMA doorbell register indicates that data is ready to be sent.

3. The server interconnect system of claim 1 wherein the first and second server nodes communicate over a PCI-Express fabric.

4. The server interconnect system of claim 1 wherein each RDMA doorbell registers include fields specifying an RDMA descriptor, the RDMA descriptor residing in system memory of the first or second server nodes.

5. The server interconnect system of claim 4 wherein the RDMA doorbell register includes a field specifying the address of the RDMA descriptor.

6. The server interconnect system of claim 5 wherein the RDMA doorbell register includes a field specifying the validity of the RDMA descriptor.

7. The server interconnect system of claim 6 wherein the RDMA doorbell register includes a field specifying size of the RDMA descriptor.

8. The server interconnect system of claim 4 wherein the RDMA descriptor includes a field specifying the identification of the remote node with which a RDMA transfer will be established.

9. The server interconnect system of claim 8 wherein the RDMA descriptor includes a field specifying the address of a local buffer that will receive data from a remote server and a field specifying the address of a remote buffer on a remote server.

10. The server interconnect system of claim 9 wherein the RDMA descriptor includes a field specifying the address of a local buffer that will receive data from a remote server and a field specifying the address of a remote buffer on a remote server.

11. The server interconnect system of claim 1 wherein the first and second server nodes each independently include a plurality of additional RDMA doorbell registers.

12. The server interconnect system of claim 1 operable to perform an RDMA read.

13. The server interconnect system of claim 1 operable to perform an RDMA write.

14. A method of sending data from a source server node having an associated first interface unit to a target server node having an associated second interface unit via a communication's switch, the method comprising:
a) registering a source buffer that is the source of the data, the first buffer being associated with the source server node;
b) registering a target buffer that is the target of the data, the target buffer being associated with the target server node;
c) creating an RDMA descriptor in system memory of the source node, the RDMA descriptor having a field that specifies identification of the target node with which a RDMA transfer will be established, an address of the source buffer, an address of the target buffer, and an RDMA status register;
d) writing the address of the RDMA descriptor to a set of first RDMA doorbell registers located within the first interface unit;
e) setting an RDMA status register to indicate an RDMA transfer is pending; and
f) providing the data to be transferred, the address of the target buffer and target node identification to the server communication switch, thereby initiating an RDMA transfer of the data to the target server node.

15. The method of claim 14 further comprising:
g) routing the data to the target interface unit; and
h) writing the data to the target buffer.

16. The method of claim 14 wherein the source and target server nodes communicate over a PCI-Express fabric.

17. The method of claim 14 wherein the RDMA doorbell register include fields specifying the RDMA descriptor and a field specifying the validity of the RDMA descriptor.

18. The method of claim 14 wherein the RDMA doorbell register includes a field specifying the address of the RDMA descriptor and a field specifying size of the RDMA descriptor.

19. The method of claim 14 wherein the RDMA descriptor includes a field specifying the address of the source buffer and the address of the target buffer.

20. A method of sending data from a source server node having an associated source interface unit to a target server node having an associated target interface unit via a communication's switch, the method comprising:
a) registering a source buffer that is the source of the data, the first buffer being associated with the source server node;
b) sending a source buffer identifier to the target server node;
c) registering a target buffer that is the target of the data, the target buffer being associated with the target server node;
d) creating an RDMA descriptor in system memory of the target node, the RDMA descriptor having a field that specifies identification of the target node with which a RDMA transfer will be established, an address of the source buffer, an address of the target buffer, and an RDMA status register;
e) writing the address of the RDMA descriptor to a set of target RDMA doorbell registers located within the target interface unit;
f) setting an RDMA status register to indicate an RDMA transfer is pending;
g) sending a request to the source interface unit to transfer data from the source buffer; and
h) sending the data from the source buffer to the target buffer.
